(19) United States
(12) Patent Application Publication
(10) Pub. No.: US 2004/0169664 A1
(43) Pub. Date: Sep. 2, 2004

(54) Method and apparatus for applying alterations selected from a set of alterations to a background scene

(76) Inventors: Michael T. Hoffman, Durham, NC (US); Steven L. Petersen, Bellevue, WA (US)

Correspondence Address: MACMILLAN SOBANSKI & TODD, LLC, ONE MARITIME PLAZA FOURTH FLOOR, 720 WATER STREET, TOLEDO, OH, 43604-1619, US

(21) Appl. No.: 10/793,557

(22) Filed: Mar. 4, 2004

Related U.S. Application Data
(63) Continuation of application No. PCT/US02/28366, filed on Sep. 6, 2002.
(60) Provisional application No. 60/317,642, filed on Sep. 6, 2001.

(51) Int. Cl. G06T 11/20

(52) U.S. Cl. 345/629

(57) ABSTRACT

An apparatus and a method for capturing the visual appearance of each alteration in a set of potential physical alterations of an object or class of objects, such that the potential application of any combination of alterations from that set applied to an object of that class can be represented visually even if that combination of alterations has never actually been physically applied to an object of that class. The visual representation can be a digital image file of photographic quality and accuracy with no visible anomalies between the background image and the applied alterations. The physical alterations can be intended to communicate a textual message.

### CROSS-REFERENCE TO RELATED APPLICATION

This application is a continuation of International Application No. PCT/US02/28366, filed Sep. 6, 2002, which application claims the benefit of U.S. provisional patent application serial No. 60/317,642, filed Sep. 6, 2001.

### BACKGROUND OF THE INVENTION

The present invention relates generally to a method and an apparatus for the placement of multiple overlay alterations at different locations in a single background scene using alterations selected from one or more sets of possible alterations.

Various methods for the manipulation of images are known. The U.S. Pat. No. 5,060,171 shows an image enhancement system and method that includes means for superimposing a second image, such as a hair style image, over portions of a first image, such as an image of a person's face. The system or method further automatically marks locations along the boundary between the first and second images and automatically calls a graphic smoothing function in the vicinity of the marked locations, so the boundary between the images is automatically smoothed. Preferably, the smoothing function calculates a new color value for a given pixel in the vicinity of such a marked location in at least two smoothing steps, the first of which calculates the color value for each of a plurality of pixels adjacent to the given pixel by combining color values from pixels which are separated, respectively, from each of those plurality of pixels by a distance of more than one pixel. The second step calculates the new color value for the given pixel by combining the color value of each of the plurality of pixels. When used to superimpose hair styles, the system includes means for defining locations on the hair style image, means for defining locations an the head image, means for superimposing the hair style image on the head image so that the defined locations on the hair style image fit those on the head image, and means for altering the size of the hair style in horizontal and vertical directions without altering the fit of the defined locations on the hair style image to the defined locations on the head image. Preferably, in frontal images, both ears and the center of the hairline are used as the defined locations. In a side view, one ear and the center of the hairline are used as the defined locations.

The U.S. Pat. No. 5,966,454 shows methods and a system to enable a highly streamlined and efficient fabric or textile sampling and design process particularly valuable in the design and selection of floor coverings, wall coverings and other interior design treatments. A digital library of fabric models is created, preferably including digitized full-color images and having associated a digital representation of positions that are located within and which characterize the models. Via an application implemented according to conventional software methods and running on conventional hardware having high resolution graphics processing capabilities, a user may navigate among the set of alternative models, and may modify the positions of the selected models to test out desired combinations of characteristics—such as poms or yarn ends, for models of floor coverings—and view the results in high resolution. In particular, and also according to the present invention, a method is provided for substituting colors in digital images of photographic quality, while preserving their realism particularly in the vicinity of shadows. The resulting samples or designs can be stored and transmitted over a telecommunications network or by other means to a central facility that can either generate photographic-quality images of the samples, or can directly generate actual samples of the carpet or other material of interest.

The U.S. Pat. No. 6,144,890 shows a method and system for designing an upholstered part such as an automotive vehicle seat utilizing a functional, interactive computer data model wherein patterns useful for reproduction of covering material and padding of the seat are generated from a user-modified version of the data model. The data model includes frame and vehicle data, ergonomic constraint data, package requirement data, plastic trim data, restraint system data, and/or seat suspension data. The system includes a graphical display on which graphical representations of the seat are displayed including a final graphical representation which is a photo-realistic, high resolution image of the seat's appearance. The high resolution image depicts most aspects of the seat's final appearance including production-intent fabrics and coverings, plastic grains, trenches and/or styles of sewing. The patterns generated from the modified data model are useful in manufacturing a prototype of the seat thereby significantly shortening the design development cycle of the seat.

### SUMMARY OF THE INVENTION

The present invention concerns an apparatus and a method for capturing the visual appearance of each alteration in a set of potential physical alterations of an object or class of objects, such that the potential application of any combination of alterations from that set applied to an object of that class can be represented visually even if that combination of alterations has never actually been physically applied to an object of that class. The method of creating that visual representation is automated by a software program running on a computing apparatus. The visual representation can be a digital image file of photographic quality and accuracy with no visible anomalies between the background image and the applied alterations. The physical alterations can be intended to communicate a textual message and the positional relationships between any two or more alterations are determined automatically by the computing apparatus. The alterations can be applied to a background scene accurate to within a fractional pixel position for increased fidelity. However, a random quantity of horizontal, vertical and rotational positioning error, within specified minimums and/or maximums, can be introduced to add photo-realism to the resulting image. The digital image pixel data from each background and graphic overlay image pixel data source is processed in rows for efficiency. A chosen set of alterations can be one of a number of styles wherein the specification of how to apply alterations to background scenes is described using textual data conforming to the W3C XML specification. Portions of the alterations can be obscured by the background scene utilizing an image mask.

The method according to the present invention involves sequential or random selection of a graphic element from a set of unique variations, such that each subsequent use of the same graphic element can potentially show variation in the final visual representation. The method relates the storage of the graphic elements that exhibit a particular rotational orientation and the locations of one or more paths in a background image such that when the graphic elements are placed into that background image along those one or more paths, the sequence of placed elements appear to be placed linearly along that path with the correct orientation. The method relates the storage of the graphic elements that exhibit particular three dimensional perspectives and the locations of one or more paths in a background image such that when the graphic elements are placed into that background image along those one or more paths, the sequence of placed graphic elements appear to have the correct perspective in relation to the background image and placement of those elements.

The method according to the present invention places each graphic element at a fractional pixel position into the background image such that the merge algorithm creates a visual result where the placed element appears to be in the correct fractional position in relation to the background image. The method places multiple overlay alterations at different locations in a single background scene using the same set of overlay graphic elements at each location. The method places multiple overlay alterations at different locations in a single background scene using unique sets of overlay graphic elements at each location. The method automatically produces each graphic element by repeating one or more smaller graphic elements following some placement pattern, whether it be a static placement pattern, or a dynamically determined pattern such as with a random, stochastic, or other algorithm.

### DESCRIPTION OF THE DRAWINGS

The above, as well as other advantages of the present invention, will become readily apparent to those skilled in the art from the following detailed description of a preferred embodiment when considered in the light of the accompanying drawings in which:

FIGS. 1a through 1c show a typical process for creating a background image used in the method and apparatus in accordance with the present invention;

FIGS. 2a through 2e shown a typical process for creating each overlay graphic element used in the method and apparatus in accordance with the present invention;

FIG. 3 is a block diagram of the apparatus in accordance with the present invention for performing the method of the present invention;

FIG. 4 is a block diagram of the background descriptor shown in FIG. 3;

FIG. 5 is a block diagram of the overlay element descriptor shown in FIG. 3;

FIG. 6 is a block diagram of the selection descriptor shown in FIG. 3;

FIG. 7 is a schematic view of the justification modes generated by the formatting subsystem of the Variba Engine shown in FIG. 3;

FIG. 8 is a schematic view of the RowIterator outputs generated by the imaging subsystem of the Variba Engine shown in FIG. 3;

FIG. 9 is a schematic view of the matrix operations with the RowIteratorGroups generated by the imaging subsystem of the Variba Engine shown in FIG. 3;

FIG. 10 is a block diagram of the relationship between the imaging subsystem and the operation of the Variba Engine shown in FIG. 3;

FIG. 11 is a flow diagram of the Configuration process and a first portion of the Layout process performed by the Variba Engine shown in FIG. 3;

FIG. 12 is a flow diagram of a second portion of the Layout process and a first portion of the Imaging process performed by the Variba Engine shown in FIG. 3; and

FIG. 13 is a flow diagram of a second portion of the Imaging process performed by the Variba Engine shown in FIG. 3.

### DESCRIPTION OF THE PREFERRED EMBODIMENT

A process for developing a photo visualization concept in accordance with the present invention is performed according to the following steps which steps are not necessarily required to be performed in exactly the same order as presented. A Step One is developing a theme for the photo visualization concept. This generally involves developing a concept for one or more background scenes and developing one or more sets of overlaying graphic elements to be used in that series of background scenes. Each set of graphic elements may represent any combination of physical alterations to that series of background scenes. One manifestation of this technique is to capture the glyphs necessary to portray a textual message using letters, numbers, symbols, or hieroglyphics in any written human language. Each set may also include any other imaginable graphic representing an alteration to each background scene. Any one background scene may utilize more than one set of graphic elements. Any one set of graphic elements may be utilized in more than one background scene or in more than one place in a single background scene. Any number of unique variations of each desired graphic element may be captured to reduce an unnatural repeat of the same element in a scene where such variations would naturally be expected.

A Step Two is to stage or produce one or more background images. These images may be any conceivable scene, and are typically either photographed, drawn, painted, illustrated, or designed on a computer in a paint, illustration or rendering application.

A Step Three is to convert each background scene into digital form. For each scene, if the scene was originally produced in a computer application, this step is essentially done. Otherwise, this will usually involve digitally photographing the scene, or photographing the scene with photographic film and then scanning the scene using a digital scanner. If the scene was drawn or painted or otherwise produced in a flat form, the scene may be scanned directly into a computer using a scanning device such as a digital flat bed scanner.

A Step Four is to capture all graphic element overlays. Place, etch, stamp, draw, paint, or otherwise introduce all desired graphic element overlays into the background scene in whatever manner is natural and/or appropriate for that scene. For the purposes of this process, a facsimile of a portion of the background scene may be created in a different setting from the actual background scene, such as in a photo studio. A particular concept may not require that the graphic elements be introduced into the background scene at all for the purpose of capturing them in digital form. Also, a particular concept may allow for the graphic elements to be produced in a computer application even though the background scene was digitally captured from its physical form. Typically, the graphic elements are prepared in advance, however, it is possible that the graphic elements will be automatically generated at the time that the graphic element overlays are applied to the background scene as described in a Step Fourteen described below.

A Step Five is to convert graphic element overlays to digital form. Convert each variation of each graphic element to digital form in a manner similar to that described in the Step Three for each background scene. For production efficiency, several graphic elements may be converted to digital form as a group.

A Step Six is to organize the graphic elements. Optionally move all or specific sets of digitally captured graphic elements into the same computer image file or into separate computer image files for the purposes of organizing them and/or for increasing the efficiency of utilizing them.

A Step Seven is to enhance and prepare the graphic elements. Optionally modify the color, brightness, sharpness, rotational orientation, resolution, or other visual aspects of each variation of each graphic element to achieve the desired level of consistency across all elements.

A Step Eight is a boundary specification. Optionally create a computer readable specification of the boundaries of each variation of each graphic element within the total rectangular boundaries of the computer image file used to store that element. This boundary also is capable of specifying the amount of desired transparency that is to be exhibited by each pixel of the graphic element. This process is typically called creating a mask of the element.

A Step Nine is to develop boundary descriptors. Develop a computer readable description of the boundaries and size of each variation of each graphic element.

A Step Ten is to develop positional relationship descriptors. Optionally develop a computer readable description of the positional relationship of any two graphic elements such that if they are used together, this unique positional relationship can be applied to achieve the best possible visual positioning of the elements in relation to each other. Any number of such positional relationships can exist between pairs of graphic elements. Any one graphic element may be a member of zero or more positional relationships. These relationships are typically called kerning pairs when associated with textual elements.

A Step Eleven is to develop path descriptors. Optionally develop a path specification which describes the desired boundaries of the background image within the total rectangular boundaries of the computer image file used to store the background image. This boundary is typically called a clipping path and is typically used to determine which portion of the image to render in the final output.

A Step Twelve is to develop image locators. Develop a computer readable description of how to retrieve the digital image or file that represents that digital image. Each locator specifies each variation of each graphic element for each set of graphic elements and optionally, the positional location of the graphical element(s) within each digital image. Each variation of each graphical element may be stored in a separate digital image, or multiple graphical elements may co-exist in a single digital image.

A Step Thirteen is to develop relationship descriptors. Develop a computer readable description file that describes the relationship(s) between the background image, the overlay elements, and how the overlay elements are to be applied to the background image.

A Step Fourteen is the application of alterations. Once the above preparations are done, the overlay graphic elements are ready to be combined with one or more background scenes to produce the visual appearance of altered objects. The overlay graphic elements can be applied in any number of different combinations to achieve the appearance of a large variety of scene variations or object alterations, even if the resulting fabricated graphical image represents variations or alterations that never existed.

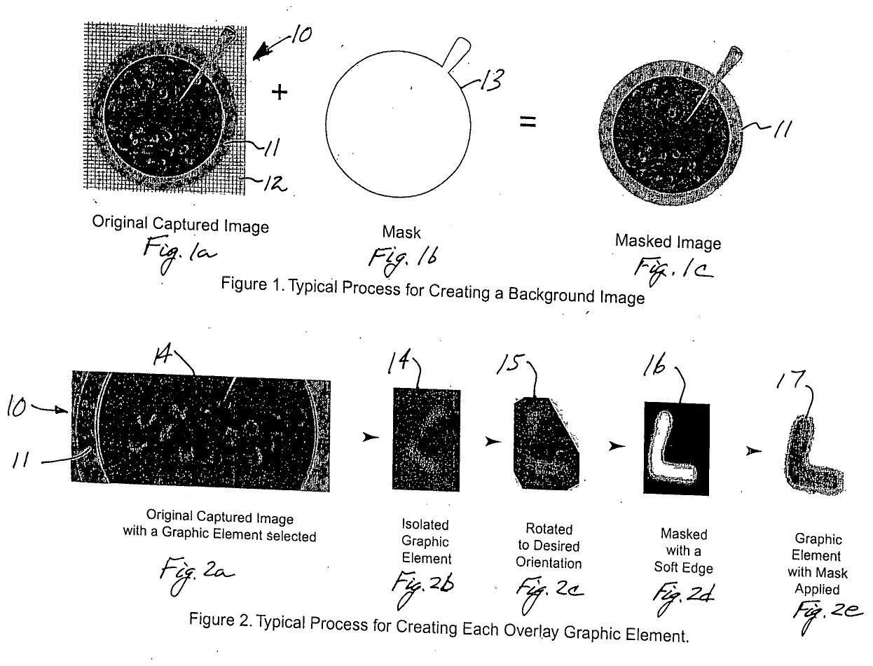

The following example illustrates the above-described process, where each step in the example correlates to the corresponding above-described method steps. As shown in FIGS. 1 and 2, the first step of developing a theme involves the concept of a bowl of tomato soup containing alphabet pasta such as those found in any available brand of Alphabet Soup, where an arbitrary textual message made of alphabet pasta letters appears to float across the middle of the soup surface. The graphical elements consist of the twenty-six capitalized letters of the alphabet, made out of pasta. The background image 11 is the bowl of soup with a spoon resting in it, where the soup is showing various bits and pieces of pasta letters across the surface of the soup except in an area reserved across the middle for showing a message made of pasta letters. If a person were to actually make a message out of pasta letters in a bowl of soup, each letter would have variations in form and positioning even if the same letter repeated in the message. To emulate this, we would like to capture several variations in pasta shape and/or positioning of possibly all the letters, but at least the most frequently used letters.

In the second step, a background image 10 of the bowl of soup 11 is staged as described above and is then photographed with a digital camera directly to a digital image file. The desired background image portion 11 is the soup bowl itself, so it can be staged on a neutral, flat background surrounding image portion 12 as shown in FIG. 1a such that it facilitates the creation of a clipping path. A mask 13 is applied to remove the surrounding image portion 12 resulting in the desired background image portion 11.

Since the image 11 was digitally captured, the only need is to transfer the image from the digital camera to the computer in the third step.

To capture each variation of each pasta letter, each letter is carefully floated to the surface of the soup in small groups 14 and then photographed as a group as shown in FIG. 2a according to the fourth step.

Since each image 14 was digitally captured, the only need is to transfer the images shown in FIG. 2b from the digital camera to the computer in the fifth step.

Using an image editing application, such as Adobe Photoshop, each variation of each letter is selected and copied into a new graphical image file large enough to contain that letter in the sixth step.

In the seventh step, each letter is checked to make sure the color of the pasta and surrounding soup is consistent and corrected if necessary. Also, some of the letters are rotated (FIG. 2c) to orient the letters correctly. Rotating the letter 15 may create areas with no soup in the background, but this will not affect the end result because a mask will be created which results in most of the background being ignored.

In this case, a mask is created (FIGS. 2d and 2e) for each image in an image editing application such as Adobe Photoshop so that when these letters are later algorithmically merged into the soup background scene, there are no transition anomalies between the soup texture in the captured letter images (16 and 17) and the soup texture in the captured background image.

In the ninth step, the pixel boundaries and pixel size of each letter is recorded into the desired Variba (see the system description below) readable format.

Kerning pairs are not critical for the concept of this example, so no kerning pairs are created according to the tenth step.

The bowl and spoon 11 is a graphic image that may be placed in other background scenes or in a page layout where the boundary of the soup is known for the purposes of text flow around the bowl. Therefore, an image editing application such as Adobe Photoshop is used to create a clipping path of just the bowl and spoon, using typical path drawing tools according to the eleventh step. Then the background image 11 is saved as an EPS format image file to preserve the clipping path in a format compatible with page layout applications.

A Variba-compatible descriptor file is created to describe the location of all of the letters of the alphabet in the twelfth step.

A Variba-compatible descriptor file is created to describe the relationships between all the elements and how to apply them in the thirteenth step.

The graphic overlay elements can now be applied to one or more background scenes in any combination to achieve the appearance of a wide variety of background object alterations in the fourteenth step.

The apparatus according to the present invention includes a Variba software system that is a collection of software components that facilitate production of photo-personalized image content. As shown in FIG. 4, an apparatus 20, which can be a programmed general purpose computer, executes the three major components of Variba software technology. One component is a Variba Designer 21—a GUI (graphical user interface) application that allows Variba content developers to create, manipulate, and organize images used to create Variba output. These images include background images, graphical element overlays, and the positioning and relationship information that describes possible variations within a particular photo-personalized design concept. The second component is a Variba Selector 22—a software component that allows Variba producers to customize their photo-personalized output within the constraints set up by the designer. The third component is a Variba Engine 23—a software component that processes constituent images to create a final, production image. The following description is of the imaging and formatting technology in this component and how it processes descriptors to create Variba output.

Descriptor Processing—The Variba components communicate via descriptors. Descriptors are machine- and human-readable plain text streams formatted in the XML 1.0 markup language. The descriptors define all of the data required to produce Variba output images.

A background descriptor 24 provides the range of possible variations of photo-personalization for a particular background image and artistic concept. As shown in the FIG. 4, the background descriptor 24 includes a background image URL 25 which property specifies the location of the background image data stream. A Variba imaging subsystem auto-detects the image format, and uses the image data to create the photo-personalized output image. All major image formats are supported.

Also included in the background descriptor 24 are drawing boundaries 26 that mark off areas of the image that are valid for overlay element placement. Multiple drawing boundaries 26 can be defined to allow any level of customization in the production process.

Further included in the background descriptor 24 are named 3D drawing paths 27 whereby the designer can specify any number of complex paths on which to place overlay elements. Complex paths 27 are defined as an aggregation of contiguous segments, which are represented by three-dimensional point data. Segments can be simple lines, arcs, and splines, allowing for representation of very complicated drawing paths. The first drawing path or drawing area in the background descriptor is considered by the Variba Engine to be the “default” path or drawing area.

Finally, included in the background descriptor 24 are named 3D drawing areas 28 by which the designer can specify any number of three-dimensional drawing areas in which to apply overlay elements. The drawing areas 28 can be defined as complex three-dimensional shapes such as rectangles, ovals, triangles, and complex closed curves. The drawing area 28 contains a drawing path that is used to establish the path that the overlay elements follow; the actual location of the overlay elements is dictated by the vertical justification property in the selection descriptor. Arrays of overlay elements are supported.

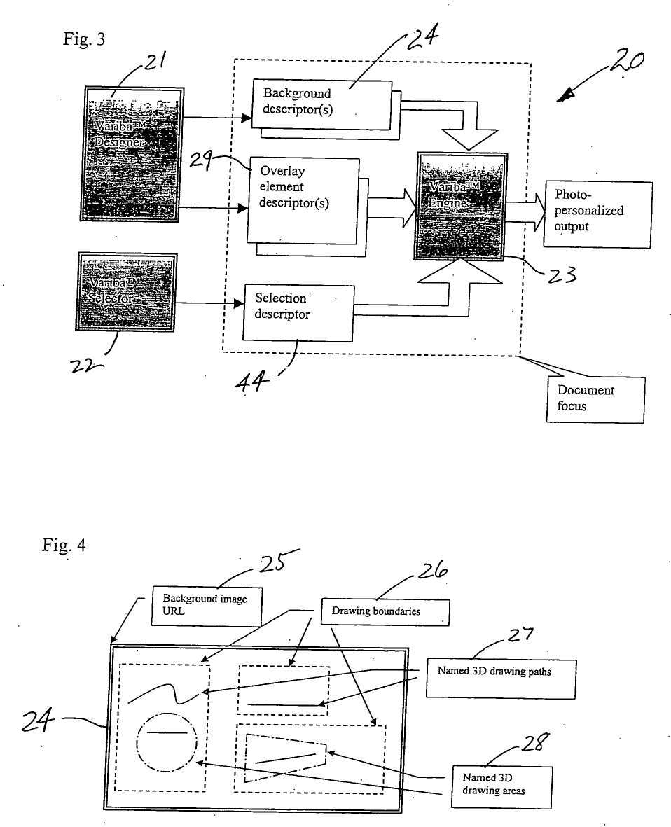

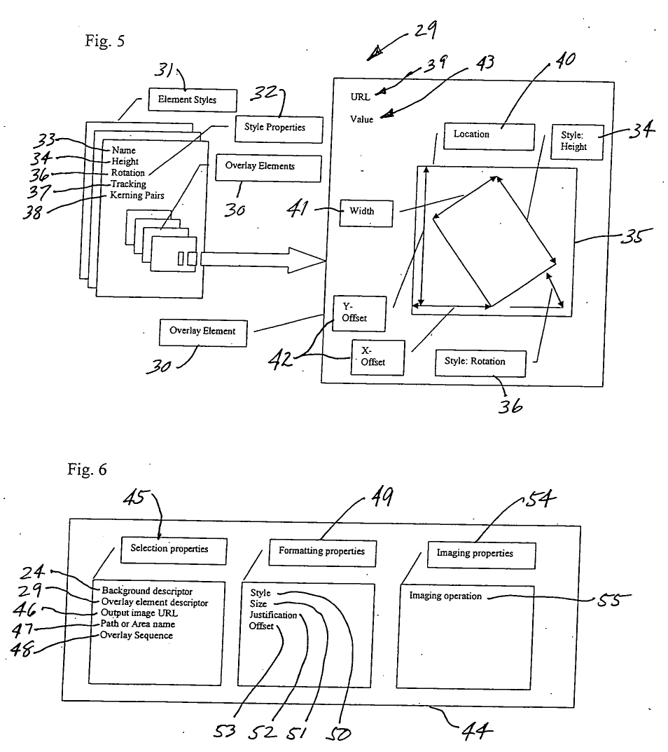

In FIG. 3, an overlay element descriptor 29 holds information pertaining to overlay elements that are available for a particular design concept. As shown in FIG. 5, the overlay elements 30 are grouped into element styles 31, which have style properties 32 that govern all elements in the style. The overlay elements 30 also have their own unique properties.

A style name 33 is provided that is a unique identifier for a group of overlay elements 30. A style height 34 identifies the design height, in pixels, of the group of overlay elements. This property is used in the justification and copy-fitting process to accurately place the overlay elements 30. The design height is defined as the height of the true image data within a bounding box 35, perpendicular to the tangent of the drawing path. A style rotation 36 identifies the intrinsic rotation of the overlay element within the bounding box 34. This value represents a counter-clockwise rotation from the horizontal, anchored by the lower left pixel. A style tracking 37 identifies the preferred inter-element spacing for this element style. A style kerning pair 38 identifies two elements that have special inter-element spacing requirements. This property consists of the two overlay element values and a positive or negative offset from the tracking value that should be applied when the two elements appear sequentially.

The overlay element 30 has a URL 39 that identifies the location of the image data stream. The element URL 39 may contain one, multiple, or all overlay elements belonging to an element style. An element location 40 identifies the pixel coordinates (Left, Top) and pixel dimensions (Width, Height) of the overlay element's bounding box 35 within the image data stream. The bounding box 35 can be any rectangular region that fully encloses all of the relevant image information for an overlay element. An element width 41 is the design width, in pixels, of the overlay element 30. The design width is defined as the width of the true image data within the bounding box 35, parallel to the tangent of the drawing path (along the angle of rotation). An element offset 42 in the form of an X-offset and a Y-offset identifies the location of the lower left pixel (anchor pixel) of the overlay element 30 relative to the upper left pixel of the element's bounding box 35. This information is used to place the overlay element 30 within the background image's drawing area or drawing path. An element value 43 identifies the overlay element 30 within its style. Styles may have multiple overlay elements 30 with the same value property. In this case the overlay elements 30 will be used sequentially, allowing pseudo-random variation in overlay elements representing the same value.

A selection descriptor 44 (FIGS. 3 and 6) provides a way to select a subset of the possible design combinations specified by the background and overlay element descriptors, as well as provide formatting and imaging customization information to the Variba Engine 23. The selection descriptor 44 uses selection properties 45 that include the background descriptor 24 and the overlay element descriptor 29 which properties identify the background and overlay element descriptors to use for the current production run. An output image URL 46 defines the location of the output image. A path or area name 47 selects the drawing path or drawing area in which to place overlay elements 30. An overlay sequence 48 identifies the sequence of overlay element values to be placed within the background image. The overlay sequence 48 can have special characters that cause formatting changes, such as moving to a subsequent drawing path or drawing area, or changes in justification.

The selection descriptor 44 uses formatting properties 49 that include style 50 and size 51 which properties identify the style name and size of the overlay elements 30 in the overlay sequence. If one or both of these are missing, the formatting engine will select the best candidate from elements that have been partially qualified by these properties. A justification property 52 specifies the location of the overlay element sequence with respect to the drawing path or drawing area. This property has a horizontal component and vertical component. Vertical justification is ignored if a drawing path is specified. Valid horizontal values are left, right, center, full and even, and valid vertical values are top, bottom, and center. An offset property 53 specifies a horizontal and vertical offset from the placement defined by the justification property 52. This allows the selection descriptor 44 to “fine-tune” placement within the given constraints.

The selection descriptor 44 uses imaging properties 54 that include an imaging operation 55 that specifies the imaging operation to perform on the overlay elements 30 and the background image.

The Variba Engine 23 formatting subsystem is designed to allow a wide range of placement options for the overlay elements 30. A second goal is to provide a format verification mode that does no image manipulation, such that immediate feedback can be returned by the engine to warn of a problem formatting the overlay element sequence. Once a data combination has been verified, image manipulation can occur. The third goal of the formatting subsystem is speed and low resource consumption.

The drawing path or drawing area is initially selected by name in the selection descriptor 44. If no drawing path or drawing area is specified in the descriptor, the first path or drawing area specified in the background descriptor 24 (the default path or drawing area) is used. The formatting engine searches the overlay sequence for special values (specifically, a value representing an end-of-line character, 1x0A). If the overlay sequence contains these values, the sequence is split into multiple groups such that subsequent values in the sequence are moved to the subsequent paths or drawing areas specified in the background descriptor. “Running out” of paths or drawing areas constitutes a formatting error, which will be reported back to the user, but may also be used to halt further processing.

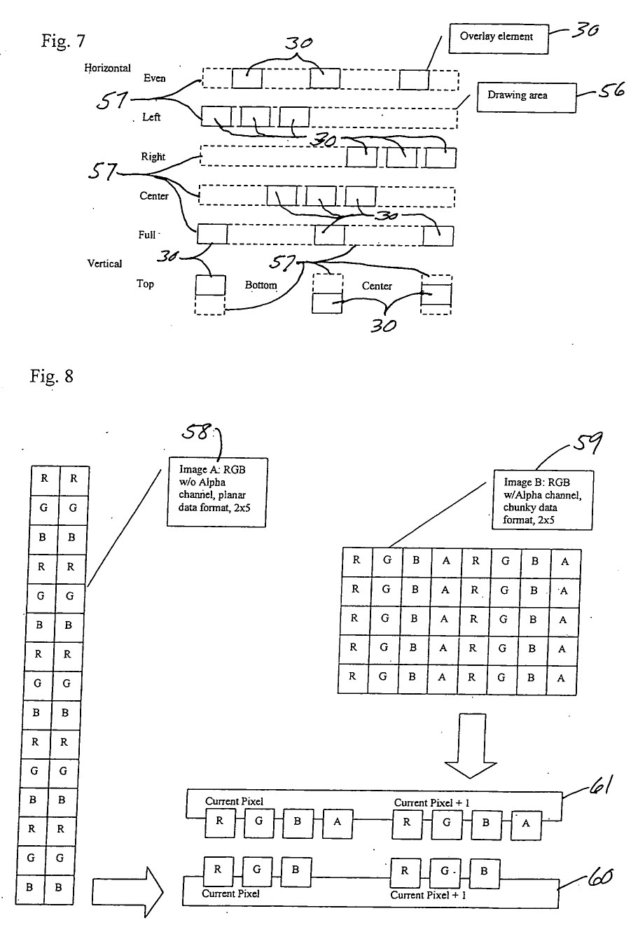

The overlay elements 30 can be transformed to incorporate three-dimensional effects, such as decimation to achieve a perspective effect, and color fading. A mathematical representation of the transformed overlay element 30 is used in the formatting process, so that imaging does not have to be performed. The formatting subsystem allows for multiple justification modes, in both the horizontal and vertical directions. Vertical formatting is valid only for drawing areas, and does not apply to overlay elements 30 on a drawing path. The following justification modes are available, as shown on a simple drawing area 56 in FIG. 7. For justification on a drawing path 57, overlay elements 30 are placed at a point calculated based upon the justification mode, the width of the elements, and the spacing of the elements in the sequence, taking into consideration kerning pairs. The lower left pixel of the overlay element 30, as specified by the overlay element descriptor 29, is placed on the drawing path 57 at the calculated point. The width of the element 30 is calculated as a function of both the width and the height of the element, due to the rotation of the element with respect to the tangent of the path 57 at that particular point. Because of this, and because the drawing path 57 is allowed to be complex, the formatting process may be an iterative operation, which is terminated when placement error has been reduced to an acceptable level.

For justification in the drawing area 56, the associated drawing path 57 is used to provide relative horizontal and vertical spacing between overlay elements 30, much in the same manner as along a drawing path. However, absolute horizontal and vertical position is determined by the justification mode. In other words, the associated drawing path “floats” vertically to allow the overlay elements to satisfy the vertical justification property specified in the selection descriptor 44. Once an instance of the drawing path 57 has been anchored within the drawing area 56, multiple rows of the overlay elements 30 can be placed in a drawing area, on a replica of the drawing path transposed in the vertical direction by a distance equal to the height of the overlay element style.

The overlay elements 30 are selected by the selection descriptor 44 using the style 50 and the size 51 properties. If one of these properties is not specified, the formatting subsystem will attempt to use the best example of overlay element styles made available by the background descriptor 24. For example, if the size property 51 is not specified, the formatter uses the largest size of the overlay element style provided in the background descriptor 24 that avoids a formatting error. This may be an iterative process.

Along with the style and size of overlay elements, the style's rotation 36 is considered during the copy-fitting process. The Variba formatting subsystem allows pre-rotated overlay elements 30, which makes faster and more accurate imaging possible when using a non-horizontal drawing path 57 or an irregular drawing area 56. The formatting subsystem will try to use the best combination of style, size and rotation from the overlay element styles available.

The collection of overlay elements 30 can be moved as a group by using the global offset property in the selection descriptor 44. Movement is only allowed within the drawing boundary; if an offset is applied that forces one or more of the overlay elements 30 outside of the drawing boundary, this causes a formatting error. This feature is available for fine-tuning the position of the overlay elements 30 within the background image.

The Variba Engine imaging subsystem is designed to support imaging operations of any complexity on images with potentially disparate data formats. To accomplish this goal, a modular, object-oriented design approach was taken, resulting in the general-purpose image operation interface described below. The imaging operation interface is used to perform built-in transformations on the overlay elements 30, as well as to combine the overlay elements with the background image. The latter operation is specified using the imaging operation property 55 of the selection descriptor 44, allowing different effects to be achieved based on the desired Variba output.

At the heart of the Variba Engine image subsystem design is a RowIterator image processor that provides a common representation of a row of image pixels, regardless of the image's internal representation of the pixel or the width of the image. FIG. 8 shows two disparate image formats 58 and 59, and their resulting RowIterator outputs 60 and 61 respectively. The RowIterator image processor provides a common interface to pixels on a designated row of any given image. A RowIterator object has a current pixel property that identifies the currently active pixel. Pixels in the row can be accessed sequentially by advancing the current pixel through the row, or randomly by offset from the current pixel. This makes it easy to perform successive one-dimensional matrix operations on each pixel of the row.

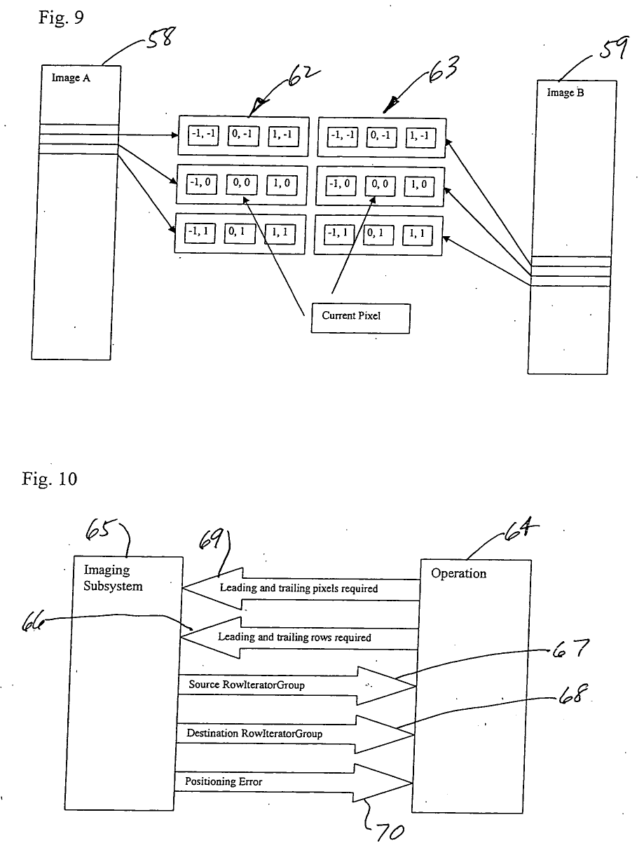

A RowIteratorGroup is an object that allows easy access to any given row of an image relative to the current row. As its name implies, it is a group of RowIterator outputs that allows special operations on the rows as a group. Used in combination with the RowIterator pixel-addressing capabilities, the RowIteratorGroup object allows two-dimensional matrix operations to be performed on any given pixel in an image. As shown in the example of FIG. 9, three rows from each of the images 58 and 59 form RowIteratorGroup objects 62 and 63 respectively. The current row of a RowIteratorGroup object can be advanced through the image simply by adding a new row to the group, displacing the oldest row. The relationship between the rows is maintained throughout the advancing process.

With reference to FIG. 10, an operation 64 is an interface that allows a specific image manipulation algorithm to be used by the imaging subsystem 65, with the subsystem having to know little about the actual algorithm used. To support this interface, an operation object must provide to the imaging subsystem 65 some information concerning its imaging requirements, and it must accept some information from the subsystem concerning the images involved in the operation. This give-and-take relationship is shown in FIG. 10.

The operation object is defined on a row-by-row basis. In other words, the imaging subsystem 65 must know how many rows are involved in the imaging operation, and call the operation object for each of these rows. Based upon the leading and trailing rows required 66, the imaging subsystem 65 builds a source RowIteratorGroup 67 for the source image and a destination RowIteratorGroup 68 for the destination image, and is responsible for advancing the RowIteratorGroup correctly between calls to perform the operation 64. Additional information provided by the operation 64 can be leading and trailing pixels required 69 and additional information generated by the imaging subsystem 65 can be positioning error 70.

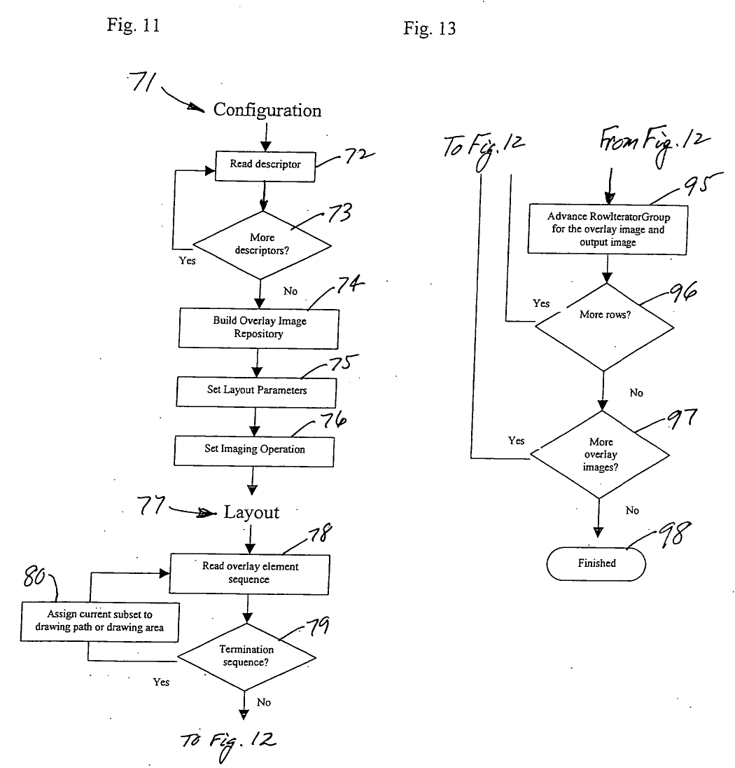

The Variba Engine 23 follows three processes to create Variba output: configuration, layout, and imaging. A first process is the Configuration process 71 shown in the flow diagram of FIG. 11. The Variba engine 23 was designed as a generic image processing system, with a framework that allows customization during the Configuration process 71. The benefits of this approach are that software components that use the engine can perform operations without specific knowledge of the operations performed. This allows the image processing intelligence to flow into the framework via the descriptors, resulting in a potentially different custom image processor for each run of the engine. This architecture lends itself very well to distributed, component-based software systems.

During the Configuration process 71, the Variba Engine 23 reads each descriptor in a step 72 and checks for more descriptors to be read in a decision point 73. The software objects are built and stored in a step 74. From the stored contents, the layout parameters are initialized in a step 75 and the imaging operation is set in a step 76. The object-oriented nature of the Variba Engine 23 allows most of the run-time decision making to be governed by the object creation process during configuration. The result of this design is that run-time decision making is kept to a minimum, thus reducing processing time.

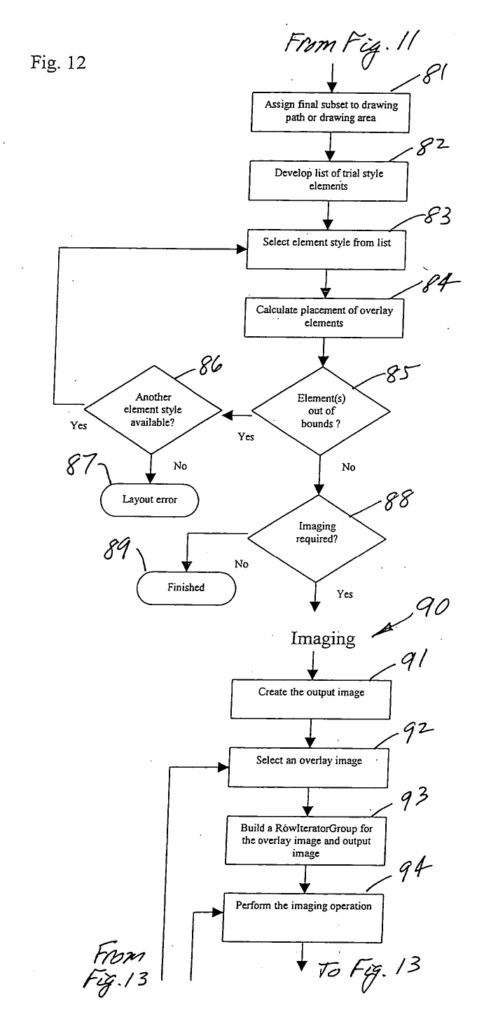

Once the Variba Engine 23 has been configured, the Layout process 77 commences. The Layout process 77, as shown in FIGS. 11 and 12, begins by parsing the overlay element sequence into groups, based on termination characters in the sequence, and assigning a named drawing path or drawing area for each subset of the element sequence. At any time, if the layout process runs out of drawing paths or drawing areas for elements, a layout error is returned from the Variba Engine 23 and can be used to halt further processing. The overlay element sequence is read in a step 78 and checked for a termination sequence in a decision point 79. If it is not a termination sequence, a step 80 assigns the current subset to a drawing path or drawing area and returns to the step 78. If it is a termination sequence, a step 81 assigns the final subset to a drawing path or drawing area and proceeds to a step 81.

In the step 81, the Layout process 77 develops a list of overlay element styles that satisfy the selection criteria from the descriptor information. The Layout process 77 selects a style element from the list in a step 83 and calculates placement of overlay elements within the drawing area or drawing path in a step 84. If a layout error occurs (an element is out of bounds), the process branches at a decision point 85 and another trial element is chosen in the step 83 and the process is repeated. If the list of trial element styles is exhausted as determined in a decision point 86, a layout error is returned in a step 87.

At the end of the Layout process 77, all of the layout information has been processed, resulting in a simple list of overlay images and their locations relative to the background image. This information is the input to the Imaging process. If a layout-only operation was specified as determined in a decision point 88, the Variba Engine 23 will return the status of the layout operation at a step 89. Otherwise, the Imaging process 90 commences.

The Imaging process 90 is shown in the FIGS. 12 and 13. At this point, the imaging engine has all it needs to process the background image and the overlay images to create the output image in a step 91. For each overlay image in the list selected in a step 92, the Imaging process 90 builds RowIteratorGroups for both the overlay image and the background in a step 93, and submits these to the image processing operation in a step 94, once for each row in the intersection between images. After each row is processed, the RowIteratorGroups are advanced to center on the next row in the intersection in a step 95. This process is carried out for all rows, as checked in a decision point 96 in all overlay images in the list. Once all of the images in the list have been processed as checked in a decision point 97, the imaging process has completed, and the engine returns any status that has accumulated from the Imaging process 77 in a step 98.

The actual algorithm for determining the resulting destination image pixels based on the current background image pixel and overlay image pixel, is flexible, by design. The typical algorithm will utilize an alpha mask value associated with each pixel of the background scene, and an alpha mask value associated with each pixel of the overlay image being processed, as weights to determine the quantity of color to come from the background scene and the quantity of color to come from the overlay image. The alpha mask values are used as fractional weights to determine this ratio.

When determining the ideal placement of an overlay image in relationship to the background image, the pixels of the overlay images may not exactly align with the integral pixel positions of the background scene. To increase the fidelity of the resulting image alteration, more than one pixel in the overlay image may be utilized to determine the value of each resulting destination image pixel based on an algorithm that utilizes weights that are in relationship to the mask values associated with each background scene pixel, the mask values associated with each overlay image pixel, and the distances from the current pixel being processed and the ideal non-integral position that can not be achieved directly due to the integral nature of image pixels. This is accomplished by first determining the closest matching pixel position in the current overlay image being processed, and the current pixel being processed from the background scene. A finite set of pixels in proximity to the ideal overlay image pixel is then utilized to calculate the resulting pixel color value. This resulting color is the summation of a weighted value for each source pixel in that proximity multiplied by that pixel's color value and the background scene's pixel color value multiplied by the weighted value represented by the alpha mask for that pixel.

The Variba Engine 23 and the data required to alter graphic images is entirely self contained, enabling it to function on a wide variety of computing apparatuses and utilizing a minimum amount of computer storage and external resources. The method according to the present invention also can be used to place a personalized message in a static/still portion of a full motion video and to capture graphic elements as full motion video and place these images into a full motion video.

In accordance with the provisions of the patent statutes, the present invention has been described in what is considered to represent its preferred embodiment. However, it should be noted that the invention can be practiced otherwise than as specifically illustrated and described without departing from its spirit or scope.

What is claimed is:

1. A method for the generation and placement of multiple overlay images at different locations in a single background image to generate an output image, each of the images including rows of pixels, comprising the steps of:
a) defining a background descriptor for a background image having rows of pixels;
b) defining an overlay element descriptor for each of an associated one of a plurality of overlay element images each having at least one row of pixels;
c) defining a selection descriptor including the background descriptor, a subset of the overlay element descriptors associated with selected ones of the overlay element images, formatting properties and imaging properties;
d) performing a configuration of a software engine utilizing the selection descriptor to generate objects, layout parameters and an imaging operation;
e) performing a layout of the overlay element images associated with the subset of the overlay element descriptors relative to the background image by assigning one of a drawing path and a drawing area to each of the selected ones of the overlay element images; and
f) performing an imaging by processing the background image and the selected ones of the overlay element images according to the layout to generate an output image.

2. The method according to claim 1 wherein said steps a) and b) are performed by creating the descriptors as digital files formatted in XML markup language.

3. The method according to claim 1 wherein said step d) includes building an overlay image repository of the objects.

4. The method according to claim 1 wherein said step c) includes setting a sequence of the overlay element images.

5. The method according to claim 1 wherein said step e) includes parsing the sequence of the overlay element images into subset groups and assigning one of a drawing path and a drawing area to each of the subset groups.

6. The method according to claim 1 wherein said step e) includes assigning at least a second one of a drawing path and a drawing area to one of the selected ones of the overlay element images.

7. The method according to claim 1 including a step of grouping related overlay element images into at least two different sets and said step c) is performed by selecting at least one of the overlay element images from each set for the subset.

8. The method according to claim 1 wherein a first variation of one overlay element image is grouped in one set and a second variation of the one overlay element image is grouped in a second set.

9. The method according to claim 1 including performing said steps b) through d) to generate a textual message in the output image with the selected ones of the overlay element images.

10. The method according to claim 1 wherein said step c) includes introducing a random quantity of at least one of horizontal, vertical and rotational positioning error to add photo-realism to the output image.

11. The method according to claim 1 said step e) is performed by building a RowIteratorGroup object for each of the selected one of the overlay element images and the background image and processing the RowIteratorGroup objects to generate the output image.

12. An apparatus for the generation and placement of multiple overlay images at different locations in a single background image to generate an output image, each of the images including rows of pixels, comprising:
a designer means for inputting a background image, a plurality of overlay element images and information related to positioning and relationship of the overlay element images to the background image;
a selector means for inputting selection information; and
an engine means having inputs connected to outputs of said designer means and said selector means for processing said background image, said overlay element images, said positioning and relationship information and said selection information to generate an output image containing said overlay elements images combined with said background image.

13. The apparatus according to claim 12 including means for converting said background image and said overlay element images to descriptors for processing by said engine means.

14. The apparatus according to claim 13 wherein said means for converting generates one of said descriptors as a background descriptor associated with said background image including information as at least one of a background image URL, drawing boundaries, named 3D drawing paths and named 3D drawing areas.

15. The apparatus according to claim 14 wherein said means for converting generates one of said descriptors as an overlay element descriptor for each of said overlay element images including information as to at least one of name, height, rotation, tracking, kerning pairs, element URL, location, width, X-offset and Y-offset and value.

16. The apparatus according to claim 15 wherein said selection information includes said background descriptor, said overlay element descriptors and information as to at least one of an output image URL, a path or area name, an overlay sequence, a style, a size, a justification, an offset and an imaging operation.

17. The apparatus according to claim 12 wherein said selection information includes an overlay sequence of said overlay element images and one of a drawing path and a drawing area within said background image, and wherein said engine means includes a formatting subsystem for positioning said overlay element images in said one of a drawing path and a drawing area in accordance with said overlay sequence.

18. The apparatus according to claim 17 wherein said engine means includes an imaging subsystem responsive to said formatting subsystem for building a RowIteratorGroup object for each of said overlay element images and said background image and processing said objects to generate said output image.

19. The apparatus according to claim 18 wherein said formatting subsystem transforms said overlay element images and said background image into a plurality of RowIterator objects, each said RowIterator object containing pixel information for an associated row of one of said overlay element images and said background image, and forms said RowIteratorGroup objects as groups of said RowIterator objects.

20. The apparatus according to claim 12 including a computer and wherein said designer means, said selector means and said engine means are software components running on said computer.
